(19) United States
(12) Patent Application Publication
(10) Pub. No.: US 2015/0169828 A1
(43) Pub. Date: Jun. 18, 2015

(54) METHOD AND SYSTEM FOR COLLECTING MEDICAL DATA

(71) Applicant: Donald SPECTOR, New York, NY (US)

(72) Inventor: Donald SPECTOR, New York, NY (US)

(21) Appl. No.: 14/633,718

(22) Filed: Feb. 27, 2015

Related U.S. Application Data
(63) Continuation-in-part of application No. 13/465,417, filed on May 7, 2012.
(60) Provisional application No. 61/487,745, filed on May 19, 2011.

(51) Int. Cl. G06F 19/00

(52) U.S. Cl. CPC G06F 19/322; G06F 19/3406

(57) ABSTRACT

A method for creating a specialized medical database uses software installed on a computer having a microprocessor and a database. The software allows a user to input search terms into the computer, whereby the software then searches the internet, including social media sites and chat rooms for posts that include the search terms. The posts are then analyzed by software that can obtain identification of the individuals. The software then contacts each of the individuals to verify the information in the post, to obtain additional information and to obtain contact information regarding each of the individuals' physicians. The software then contacts the physician to verify the information supplied by the individual. All of the information obtained in this process is then placed in a sortable format in the memory of the computer.

### CROSS-REFERENCE TO RELATED APPLICATIONS

This application is a continuation-in-part of U.S. patent application Ser. No. 13/465,417, filed on May 7, 2012, which claims priority under 35 U.S.C. §119(e) of U.S. Provisional Application Ser. No. 61/487,745, filed on May 19, 2011.

### BACKGROUND OF THE INVENTION

1. Field of the Invention

The present invention relates to a method and system for creating a specialized medical database from patient data found on the internet and verified by the patient's doctors, and for creating an instantaneous way for verifying the accuracy of a medical procedure.

2. The Prior Art

Right now, there is no centralized database that records symptoms and medical treatment for patients throughout the world. Aside from research journals and textbooks, there is no way for a doctor or researcher to gain access to a large number of patient cases for research purposes. Generally, the researcher must individually recruit the patients, and it is usually a small number. It would be ideal if a researcher could create a large, global database for a certain specialty, which then can include large numbers of patients throughout the world. The symptoms and treatments of various diseases could be compared on a much larger scale, to further refine medical research.

This database could be accessed by a surgeon during a medical procedure to verify that the procedure was done completely and accurately. For example, during an endoscopy procedure, the database could be used to instantaneously verify the presence of diseased tissue inside a patient.

### SUMMARY OF THE INVENTION

It is therefore an object of the invention to provide a way for a researcher to create a global specialized database for a particular medical subject and to connect this database to medical and surgical tools so that a physician can have instantaneous access to the database during treatment or surgery.

The invention comprises a method for creating a specialized medical database using information found on the internet. There is software installed on a computer having a microprocessor and storage memory, as well as a communication system for access to the internet. The software allows a user to input search terms into the computer, whereby the software then searches the internet, including social media sites and chat rooms for posts that include the keywords input by the user. The Cluuz Search Engine, by Sprylogics is an example of information gathering software that can automatically pin point certain words, symptoms, diseases or other associated words that can collect a database around medical information. While these systems are relatively new and are used for Homeland Security and Defense purposes to refine databases from chatter these automatic software principals can be applied to the mining of medical data from discussions, chat rooms and emails that take place on broader platforms. Commercial internet search engines are not equipped to search social media sites and chat rooms, but the software in the present invention includes features for monitoring such sites. Thus, the software is equipped to search Facebook®, Twitter®, chat rooms, message boards and all other types of sites where individuals post information. The software searches for posts of individuals that contain the keywords input by the user. The posts are then analyzed by software that can obtain identification of the individuals, in particular an email address or mobile telephone number of the individuals. Using the identification, the user or program then contacts each of the individuals to verify the information in the post, to obtain additional information and to obtain contact information regarding each of the individuals' physician. The user then contacts the physician to verify the information supplied by the individual and to obtain additional information. Information from pharmacies, which is not confidential can also be used to enhance the database, since people use certain pharmaceuticals for certain diseases, it is possible to draw plausible correlations using databases of pharmacies, in which individuals information is not held confidential, nor the referring physician. This information too can be mined as part of this medical database generating system. All of the information obtained in this process is then placed in a sortable format in the memory of the computer, to create a specialized database. The contacting could also be done automatically by the software in the computer, by sending out a pre-made form to the patient and physician requesting the additional information.

The invention also comprises a way for individuals with certain genetic characteristics to find similar individuals in chat rooms and social media to compare symptoms and other genetic information, as well as to enhance the amount of information available to the researchers using the method above. Each of the individuals has a biosensor implanted below the skin. The biosensor measures physiological or genetic characteristic of the individual and communicates this information via a transmitter to a computer having a microprocessor and a communication device. The computer takes the genetic or physiological information, processes it with software to create a genetic or physiological profile or diagnosis, and automatically searches the internet and especially social media sites for keywords that match the condition measured by the sensor. The individual is then directed to these sites so that they can participate in the discussions there. This process augments the data mining process discussed above, because it provides the physician or researcher with much more data than would normally be found on these websites. The computer can also be programmed to automatically transmit the data sensed by the biosensor to various websites for searching by the researchers. The individual can select this option when setting up the computer link to the biosensor.

The biosensor can be any commercially available biosensor. An example is disclosed in International Application No. WO 2000033065, the disclosure of which is herein incorporated by reference, and in EP 1588755B1, the disclosure of which is also incorporated by reference.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a block diagram of the process steps according to the invention; and

FIG. 2 shows an individual with an implanted biosensor that transmits to a computer for transmitting information from the biosensor to chat rooms over the internet.

### DETAILED DESCRIPTION OF THE PREFERRED EMBODIMENT

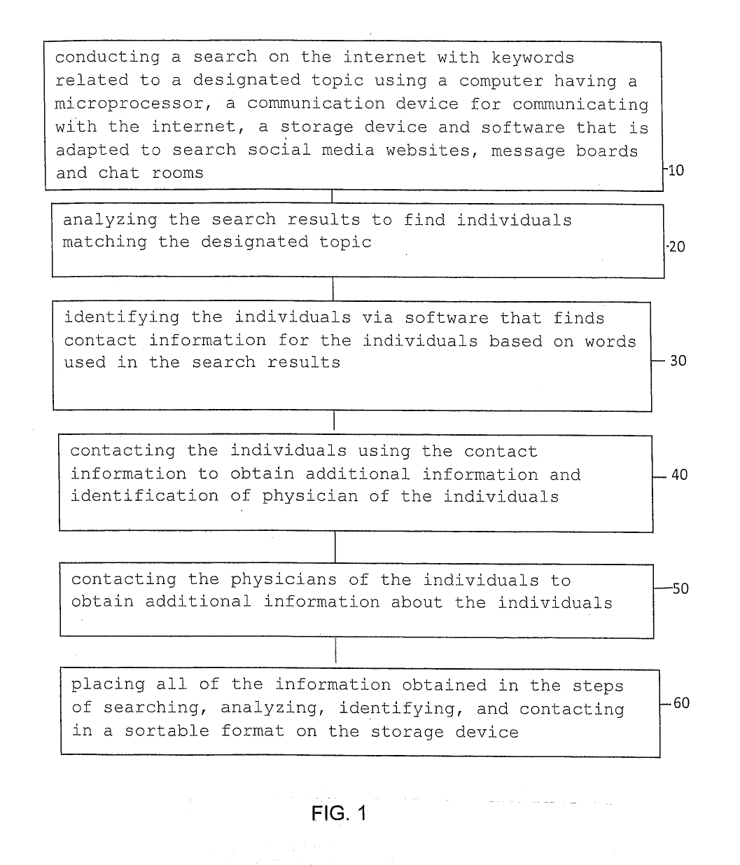

The invention as shown in FIG. 1 comprises the step 10 of conducting a search on the internet with keywords related to a designated topic using a computer having a microprocessor, a communication device for communicating with the internet, a storage device and software that is adapted to search social media websites, message boards and chat rooms. Step 20 involves analyzing the search results to find individuals matching the designated topic. In step 30, the individuals are identified via software that finds contact information for the individuals based on words used in the search results. Step 40 involves contacting the individuals using the contact information to obtain additional information and identification of physician of the individuals. In step 50, physicians of the individuals are contacted to obtain additional information about the individuals. and in step 60, all of the information obtained in the steps of searching, analyzing, identifying, and contacting are placed in a sortable format on the storage device:

In one example of the method, a cancer researcher is interested in creating a research database for case studies of ovarian cancer. The researcher has a computer in which there is a microprocessor, storage memory and a communication system for access to the internet. The computer also has software that allows the researcher to input search terms into the computer, in this case “ovarian cancer” and various terms related to symptoms and treatment, and the software then searches social media sites and chat rooms for posts that include the keywords input by the researcher. The software is particular for posts on social media cites, so that it does not search the internet in general, but only for posts generated by individuals. Commercial internet search engines are not equipped to search social media sites and chat rooms, but the software in the present invention includes features for monitoring such sites. The posts matching the keywords input by the researcher are then analyzed by the software to obtain identification of the individuals, in particular an email address or mobile telephone number of the individuals. Using the identification, the researcher then contacts each of the individuals to verify the information in the post, to obtain additional information about their condition, and to obtain contact information regarding each of the individuals' physicians. The researcher then contacts the physicians to verify the information supplied by the individuals and to obtain additional information about their diagnosis, treatment, symptoms, etc. All of the information obtained in this process is then placed in a sortable format in the memory of the computer, to create a specialized database. The contacting could also be done automatically by the software in the computer, by sending out a pre-made form to the patient and physician requesting the additional information.

The database can be shared over the internet with other physicians and researchers to aid in developing treatments for various diseases. Specifically this information is cross correlated with a blood tests and DNA or RNA matching so that the physicians of the patients can share the success of various protocols with people of similar genetic matches. It has been shown that people with similar genetic characteristics respond in a similar way to drugs and therefore in Chemotherapy or other protocols, time and the strength of the patient can be saved by going to the most probable drug for the specific disease and the person with a similar genetic map. Therefore, the addition of these new software applications combined with genetic matching and verification can be used to create the equivalent of new PDRs that are specific to a person's genetic or other physiological makeup. The use of these programs applied over large database mining will accelerate the ability of these procedures to identify people throughout the world with similar conditions, a process for creating a scientific base that would otherwise take exponentially more time.

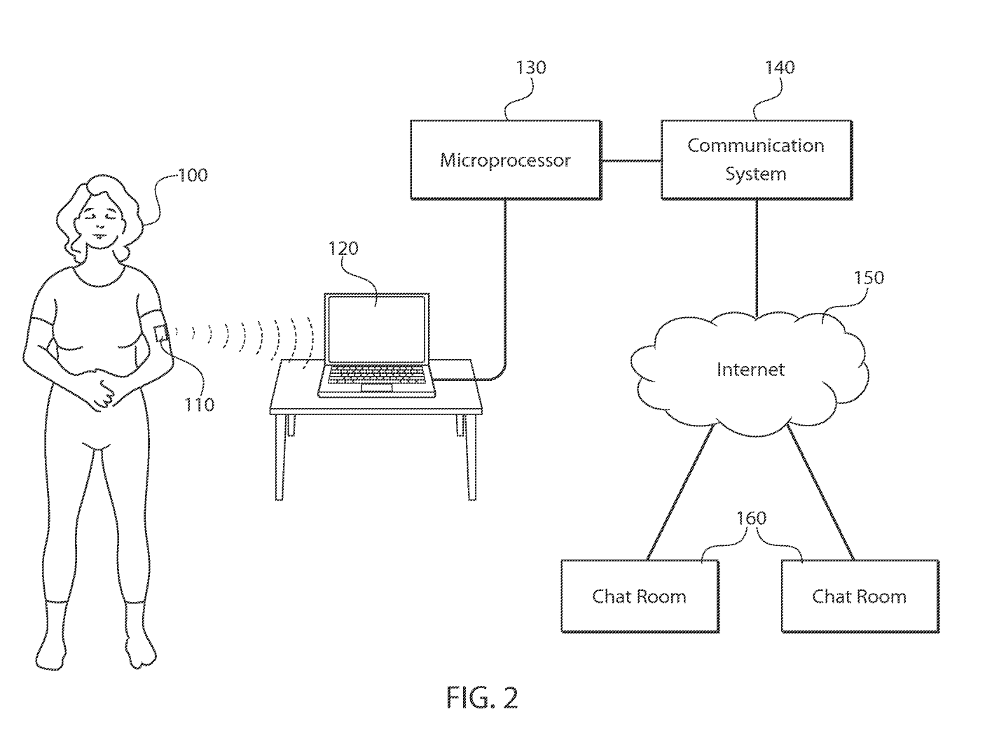

In a further aspect of the method according to the invention as shown in FIG. 2, an individual 100 is fitted with an implantable biosensor 110, which measures a physiological or genetic parameter of the individual. The measurements are transmitted to a computer 120 via a transmitter in the biosensor. A microprocessor 130 in the computer 120 then utilizes software to analyze the data transmitted from the biosensor 110 to determine a diagnosis or genetic state of the individual 100. The microprocessor 130 is connected to a communication system 140 to connect to the internet 150. Microprocessor 130 automatically searches the internet 150, particularly social media websites and chat rooms 160, for keywords matching the diagnosis or genetic state, to match the individual with the appropriate chat room or other website. The list of matching websites can be displayed on computer 120 for the individual to access, or a post on these websites can be automatically made by the microprocessor with the individual's information.

This added information from the biosensors 110 allows researchers using the method according to the invention to accumulate even more data regarding particular diseases and genetic conditions.

Accordingly, while only a few embodiments of the present invention have been shown and described, it is obvious that many changes and modifications may be made thereunto without departing from the spirit and scope of the invention.

What is claimed is:

1. A method for creating a specialized medical database, comprising the following steps:
implanting a biosensor in at least one individual, the biosensor being configured to measure at least one physiological or genetic characteristic of the individual, the biosensor being connected to a transmitter;
transmitting data measured by the biosensor to a computer having a microprocessor and a communication system adapted to communicate with the internet;
analyzing the data measured by the biosensor using the microprocessor to determine a diagnosis or genetic state of the individual;
automatically searching the internet via the microprocessor that has software that is adapted to search social media websites, message boards and chat rooms, wherein search criteria are keywords that match the determined diagnosis or genetic state; and
inputting data regarding the determined diagnosis or genetic state into at least one of the websites found in the step of automatically searching.

2. The method according to claim 1, further comprising the following steps:
conducting a search on the internet with keywords related to a the determined diagnosis or genetic state using a second computer having a microprocessor, a communication device for communicating with the internet, a storage device and software that is adapted to search social media websites, message boards and chat rooms;
analyzing the search results to find individuals matching the designated topic;
identifying the individuals via software that finds contact information for the individuals based on words used in the search results;
contacting the individuals using the contact information to obtain additional information and identification of physician of the individuals;
contacting the physicians of the individuals to obtain additional information about the individuals; and
placing all of the information obtained in the steps of searching, analyzing, identifying, and contacting in a sortable format on the storage device.

3. The method according to claim 1, wherein the steps of contacting the individual and contacting the physician takes place automatically via the microprocessor sending a form via email to the individual and the physician.

4. The method according to claim 1, further comprising the step of connecting the database to the internet so that the database is accessible by remote users.

5. The method according to claim 4, wherein the database is adapted to receive information from the remote users.

6. The method according to claim 5, wherein the database is sortable by blood type or genetic characteristics.

7. The method according to claim 1, further comprising the step of displaying results of the search on a display of the computer.

8. The method according to claim 1, wherein the step of inputting takes place automatically via the microprocessor.
